(19) United States
(12) Patent Application Publication
(10) Pub. No.: US 2026/0163274 A1
(43) Pub. Date: Jun. 11, 2026

(54) ELECTRICAL CONNECTOR AND MANUFACTURING METHOD OF ELECTRICAL CONNECTOR

(71) Applicant: Molex, LLC, Lisle, IL (US)

(72) Inventor: Shih-Hsuan Chen, New Taipei City (TW)

(21) Appl. No.: 19/413,850

(22) Filed: Dec. 9, 2025

(30) Foreign Application Priority Data
Dec. 9, 2024 (CN) 202411799265.2

(51) Int. Cl. H01R 12/77; H01R 12/79

(52) U.S. Cl. CPC H01R 12/771; H01R 12/79

(57) ABSTRACT

An electrical connector and manufacturing method are described. The electrical connector includes a housing, a circuit board, a cable, a back cover and two fixing posts. The housing has a receiving groove which is toward the rear, a through groove which is communicated with the receiving groove and is opened forwardly, two fixing protrusions which are positioned on two sides of the receiving groove, two first mounting holes which are respectively positioned on the two fixing protrusions and are penetratingly formed up and down, and two second mounting holes which are positioned on a top of the housing and respectively correspond to the two first mounting holes. The circuit board has two third mounting holes. The cable is electrically connected to the circuit board. The back cover is molded on an outer periphery of a connection between the circuit board and the cable and is mounted into the receiving groove.

### TECHNICAL FIELD

The present disclosure relates to an electrical connector, and particularly relates to an electrical connector and a manufacturing method of an electrical connector.

### BACKGROUND

Chinese patent CN218887705U discloses an electrical connection device which includes a cable-end connector. The cable-end connector includes an insulative housing, a circuit board, a cable and a locking member. The insulative housing has a body portion and a mating portion. The body portion is formed with a first opening, the mating portion is connected to the body portion and has a continuous surrounding wall which encircles the first opening, the continuous surrounding wall encircles to form an inner cavity, the inner cavity has a second opening. Each of two opposite sides of the body portion and the mating portion therebetween form a positioning space. The circuit board is provided to the body portion, partially extends out of the first opening and extends to the inner cavity. The cable is electrically connected to a side of the circuit board. The locking member is provided to the insulative housing. Thus, the cable-end connector can firmly mate with a board-end connector, so that stability of electrical signal transmission can be promoted. The insulative housing is formed with an injecting hole, the wrapping body is formed by that a plastic is injected into the insulative housing via the injecting hole and is filled in the insulative housing. The insulative housing is formed with a molding cavity which receives the wrapping body and is communicated with the injecting hole and a retaining hole which is communicated with the molding cavity, the cable-end connector further includes a retaining member, the retaining member is partially provided in the retaining hole, partially extends into the molding cavity and is securely engaged with the wrapping body. The wrapping body is formed between an upper housing and the insulative housing, it is difficult to observe whether the wrapping body is sufficiently plentifully molded from the outside, there is a risk that the wrapping body is poorly molded; in addition, because the circuit board and the insulative housing therebetween have an assembling gap, there is a risk that a melted plastic flows out via the gap between the circuit board and the insulative housing to contaminate mating gold fingers on the circuit board.

### SUMMARY

Therefore, an object of the present disclosure is to provide an electrical connector and a manufacturing method of an electrical connector which can improve at least one problem of the prior art.

Accordingly, in some embodiments, an electrical connector of the present disclosure comprises a housing, a circuit board, a cable, a back cover and two fixing posts. The housing comprises a receiving groove which is toward the rear, a through groove which is communicated with the receiving groove and is opened forwardly, two fixing protrusions which are positioned on two sides of the receiving groove, two first mounting holes which are respectively positioned on the two fixing protrusions and are penetratingly formed up and down, and two second mounting holes which are positioned on a top of the housing and respectively correspond to the two first mounting holes. The circuit board comprises a mating portion which is positioned to a front portion of the circuit board, a cable connecting portion which is positioned to a rear portion of the circuit board, and two third mounting holes which respectively correspond to the two first mounting holes. The cable is electrically connected to the cable connecting portion of the circuit board. The back cover is molded on an outer periphery of a connection between the circuit board and the cable and is mounted into the receiving groove, so that the circuit board protrudes forwardly from the through groove, the back cover comprises two first fixing portions and two fourth mounting holes which are positioned in the two first fixing portions and respectively correspond to the two first mounting holes. The two fixing posts extend up and down and pass through the two first mounting holes, the two second mounting holes, the two third mounting holes and the two fourth mounting holes.

In some embodiments, the back cover further comprises two second fixing portions which are positioned below the two first fixing portions and are spaced apart from the two first fixing portions, and two fifth mounting holes which are positioned to the two second fixing portions and respectively correspond to the two first mounting holes, the two fixing protrusions of the housing are positioned between the two first fixing portions and the two second fixing portions, the two fixing posts further pass through to the two fifth mounting holes.

In some embodiments, the back cover comprises a first molded body and a second molded body, the first molded body is directly molded on the connection between the circuit board and the cable to form a base, and the second molded body is further molded on the first molded body.

In some embodiments, the two first fixing portions and the two fourth mounting holes are formed on the first molded body.

In some embodiments, the housing further comprises a mating cavity which is toward the front, the through groove is communicated between the receiving groove and the mating cavity, the circuit board forwardly protrudes from the through groove to the mating cavity.

Accordingly, in some embodiments, a manufacturing method of an electrical connector of the present disclosure comprises steps of: preparing a circuit board with a cable connected to its rear portion, molding a back cover on the rear portion of the circuit board, the back cover is molded on an outer periphery of a connection between the circuit board and the cable, the back cover and the circuit board are provided thereon with mounting holes which are aligned with each other up and down; preparing a housing, the housing has a receiving groove which is toward the rear, a through groove which is communicated with the receiving groove and is opened forwardly, and two fixing protrusions which are positioned on two sides of the receiving groove, the two fixing protrusions and a top of the housing are correspondingly provided with mounting holes; mounting the back cover into the receiving groove of the housing with the circuit board, so that the circuit board forwardly protrudes via the through groove; downwardly pressing two fixing posts from the mounting holes on the top of the housing, so that the two fixing posts sequentially pass through the mounting holes of the housing, the mounting holes of the back cover, the mounting holes of the circuit board and the mounting holes of the two fixing protrusions, so the back cover and the circuit board are fixed to the housing.

In some embodiments, the back cover comprises two first fixing portions, and two second fixing portions which are positioned below the two first fixing portions and are spaced apart from the two first fixing portions, the two first fixing portions and the two second fixing portions both are provided with the mounting holes, after mounting the back cover into the receiving groove of the housing with the circuit board, the two fixing protrusions of the housing are positioned between the two first fixing portions and the two second fixing portions, after downwardly pressing the two fixing posts from the mounting holes on the top of the housing, the two fixing posts sequentially pass through the mounting holes of the housing, the mounting holes of the two first fixing portions of the back cover, the mounting holes of the circuit board, the mounting holes of the two fixing protrusions and the mounting holes of the two second fixing portions, so the back cover and the circuit board are fixed to the housing.

In some embodiments, the back cover comprises a first molded body and a second molded body, in the process of molding the back cover on the rear portion of the circuit board, firstly the first molded body is molded on the connection between the circuit board and the cable to form a base, then the second molded body is further molded on the first molded body.

In some embodiments, the mounting holes of the back cover are formed when the first molded body is molded on the connections between the circuit board and the cable to form the base.

In some embodiments, the housing further comprises a mating cavity which is toward the front, the through groove is communicated between the receiving groove and the mating cavity, after mounting the back cover into the receiving groove of the housing with the circuit board, the circuit board forwardly protrudes to the mating cavity via the through groove.

In the present disclosure, the back cover which is molded on the outer periphery of the connection of the circuit board and the cable is molded firstly, the back cover is then fixed onto the housing via the two fixing posts, the molded back cover may be more plentiful and precise, at the same time it can avoid a melted plastic flowing out via a gap between the circuit board and the housing to contaminate mating gold fingers on the circuit board.

### BRIEF DESCRIPTION OF THE DRAWINGS

Other features and effects of the present disclosure will be apparent from an embodiment with reference to the drawings, in which:

FIG. 1 is a perspective view of a preferred embodiment of an electrical connector of the present disclosure;

FIG. 2 is a perspective view of the embodiment viewed from another angle;

FIG. 3 is a front view of the embodiment;

FIG. 4 is an exploded perspective view of the embodiment;

FIG. 5 is an exploded perspective view of the embodiment viewed from another angle;

FIG. 6 is a further exploded perspective view of the embodiment;

FIG. 7 is a further exploded perspective view of the embodiment viewed from another angle;

FIG. 8 is a top view of the embodiment;

FIG. 9 is a cross-sectional view taken along a line A-A of FIG. 8;

FIG. 10 is a flowchart of steps of a manufacturing method of the embodiment; and

FIGS. 11-14 are schematic perspective views used to illustrate a manufacturing and assembling process of the embodiment.

Reference numerals are presented as follows.
100 electrical connector
1 housing
11 front wall
12 top wall
121 second mounting hole
122 receiving recess
13 side wall
14 side board
15 tongue
16 receiving groove
17 mating cavity
18 through groove
19 fixing protrusion
191 first mounting hole
2 circuit board
21 mating portion
22 cable connecting portion
23 wing portion
24 third mounting hole
3 cable
4 back cover
41 first fixing portion
411 accommodating groove
42 second fixing portion
43 fourth mounting hole
44 fifth mounting hole
45 first molded body
451 aperture
46 second molded body
461 filling portion
47 strap passing hole
5 fixing post
51 thread
6 locking member
7 pulling strap
D1 front-rear direction
D2 up-down direction
D3 left-right direction
S1-S4 step

### DETAILED DESCRIPTION

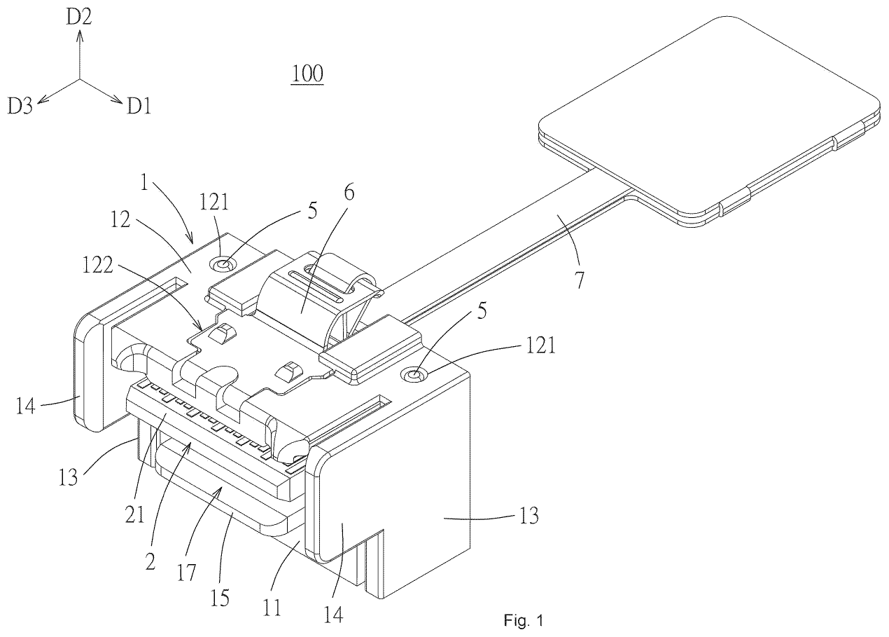

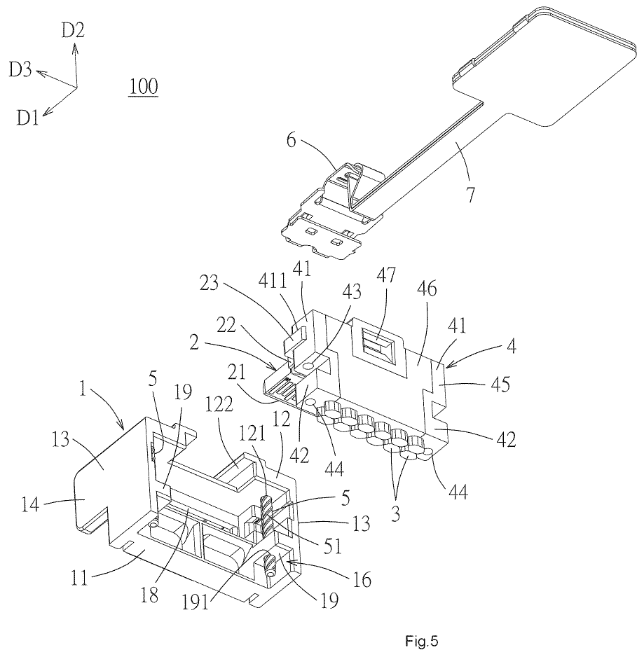

Referring to FIG. 1 to FIG. 5, an embodiment of an electrical connector 100 and a manufacturing method of the electrical connector 100 of the present disclosure are described, the electrical connector 100 includes a housing 1, a circuit board 2, cables 3, a back cover 4, two fixing posts 5, a locking member 6, and a pulling strap 7.

The housing 1 has a front wall 11 which faces the front along a front-rear direction D1 (a direction to which an arrow points is front and a direction opposite to front is rear), a top wall 12 which extends along the front-rear direction D1 from a top edge of the front wall 11 in an up-down direction D2 (a direction to which an arrow points is up and a direction opposite to up is down), two side walls 13 which extend rearwardly from two side edges of the top wall 12 in a left-right direction D3 (a direction to which an arrow points is right and a direction opposite to right is left) and are connected to the top wall 12, two side boards 14 which extend forwardly from the two side walls 13, a tongue 15 which extends forwardly from the front wall 11 and is positioned below the top wal1 12, a receiving groove 16 which is toward the rear along the front-rear direction D1 (a direction to which an arrow points is front and a direction opposite to front is rear), a mating cavity 17 which is toward the front, a through groove 18 which is communicated between the receiving groove 16 and the mating cavity 17 and is opened forwardly, two fixing protrusions 19 which are positioned on two sides of a rear segment of the receiving groove 16 in the left-right direction D3, two first mounting holes 191 which are respectively positioned on the two fixing protrusions 19 and are penetratingly formed up and down along the up-down direction D2, and two second mounting holes 121 which are positioned on the top wall 12 at a top of the housing 1 and respectively correspond to the two first mounting holes 191. Specifically, in the present embodiment, the top wall 12 and the two side walls 13 together define the receiving groove 16, the top wall 12, the two side boards 14 and the tongue 15 together define the mating cavity 17, so that another mating connector (not shown) may be guided to accurately mate with the circuit board 2.

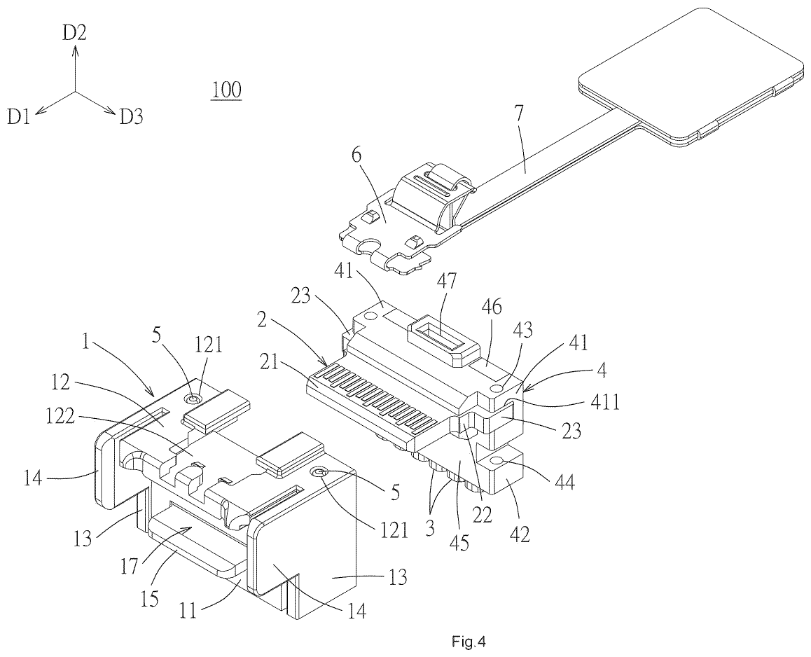

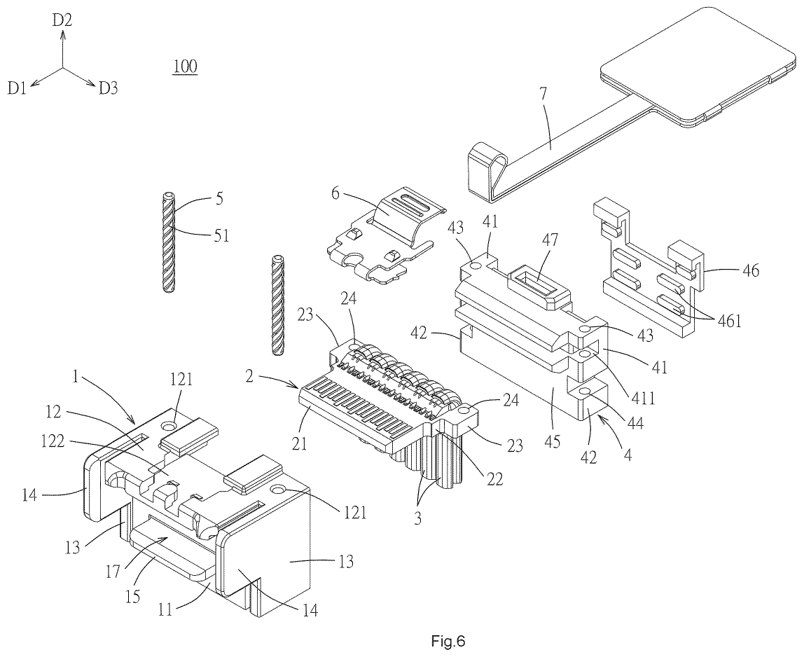

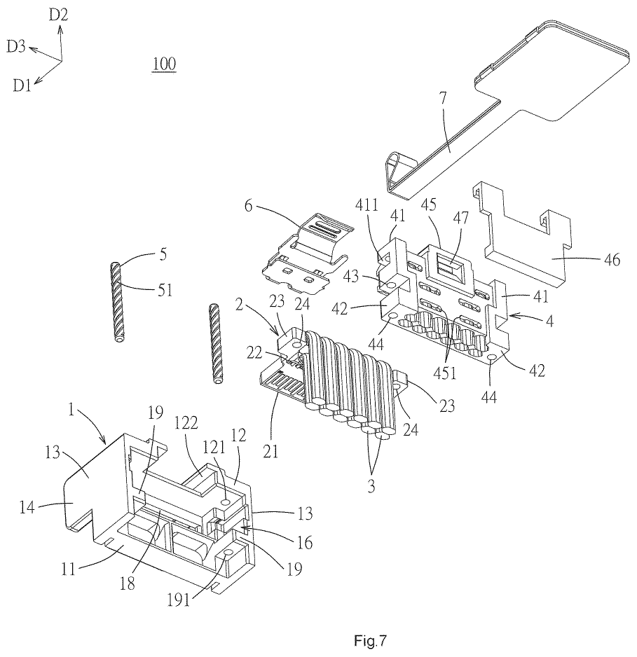

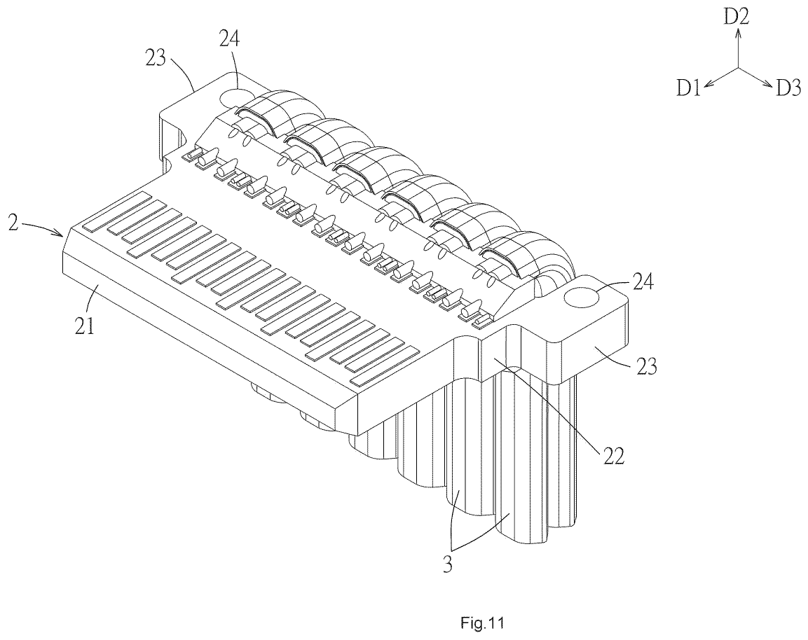

Referring to FIG. 4 to FIG. 7, the circuit board 2 has a mating portion 21 which is positioned on a front portion of the circuit board 2, a cable connecting portion 22 which is positioned on a rear portion of the circuit board 2, two wing portions 23 which respectively extend from the cable connecting portion 22 toward a left side and a right side and toward the rear, and two third mounting holes 24 which are formed to the two wing portions 23 and respectively correspond to the two first mounting holes 191. Referring to FIG. 11 together, the cables 3 are electrically connected to the cable connecting portion 22 of the circuit board 2, connections between the cables 3 and the cable connecting portion 22 are further coated with an adhesive layer to provide preliminary protection, the cables 3 bend rearwardly and downwardly and extend.

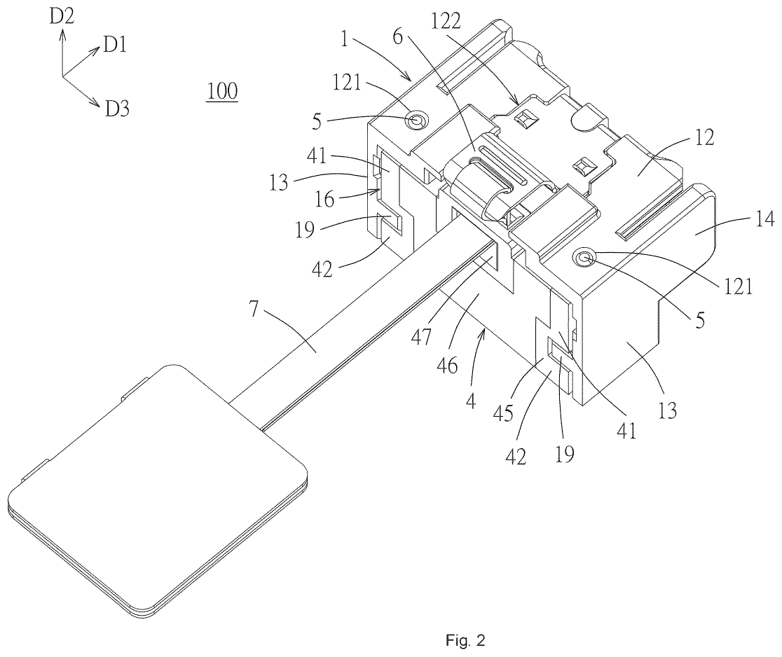

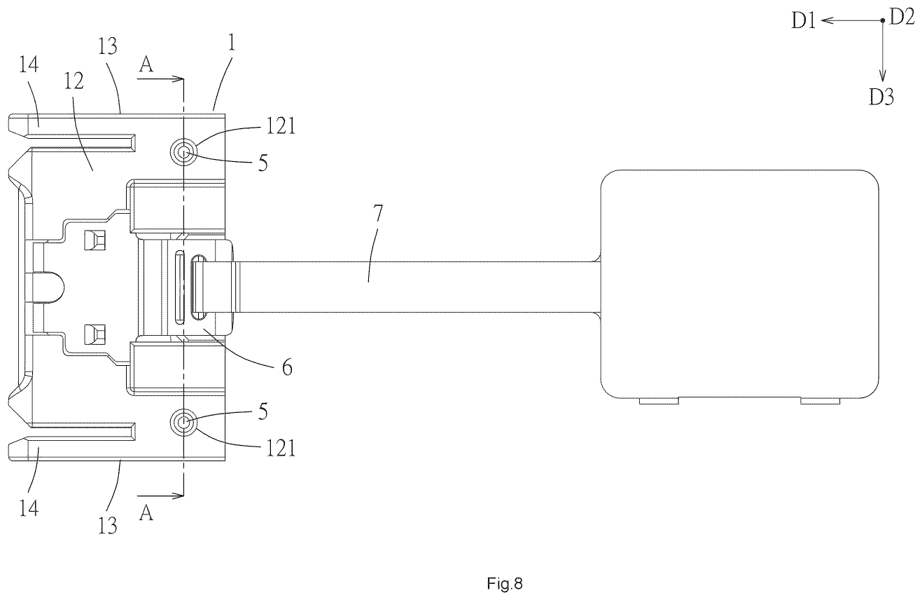

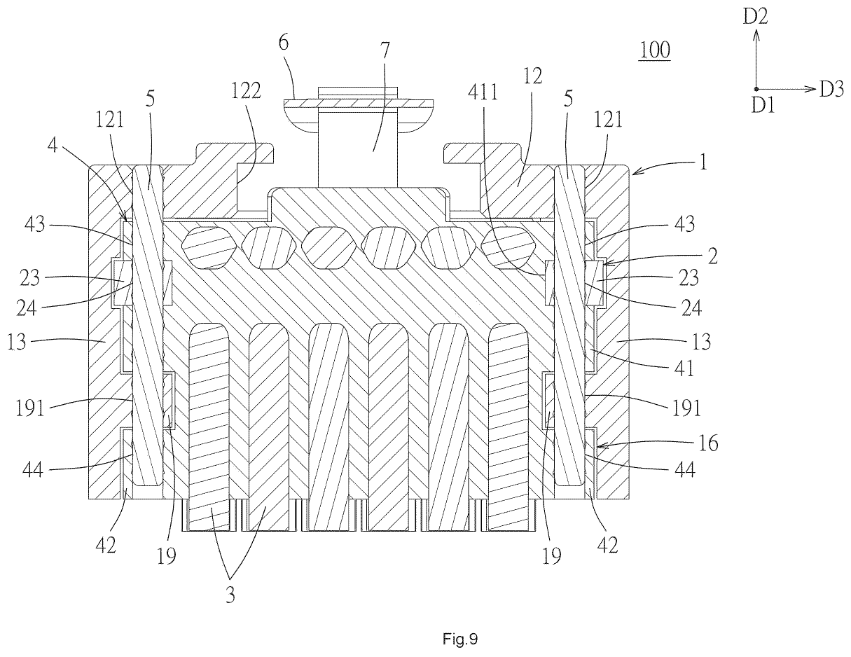

Referring to FIG. 2 and FIG. 6 to FIG. 9, the back cover 4 is molded on an outer periphery of the connections between the circuit board 2 and the cables 3 and is provided to the receiving groove 16, so that the circuit board 2 protrudes from the through groove 18 forwardly to the mating cavity 17. The back cover 4 has two first fixing portions 41 which protrude along the left-right direction D3 toward two sides of the back cover 4, two second fixing portions 42 which are positioned below the two first fixing portions 41 and are spaced apart from the two first fixing portions 41, two fourth mounting holes 43 which are positioned in the two first fixing portions 41 and respectively correspond to the two first mounting holes 191, and two fifth mounting holes 44 which are positioned to the two second fixing portions 42 and respectively correspond to the two first mounting holes 191. The two first fixing portions 41 are respectively molded on the two wing portions 23 of the circuit board 2, and each first fixing portion 41 has an accommodating groove 411 which accommodates the corresponding wing portion 23. When the back cover 4 is assembled to the receiving groove 16 of the housing 1, the two fixing protrusions 19 of the housing 1 are positioned between the two first fixing portions 41 and the two second fixing portions 42. Providing the two second fixing portions 42 and the two fifth mounting holes 44 on the two second fixing portions 42 may strengthen firmness of the back cover 4, but in some embodiment not shown, the two second fixing portions 42 may be omitted. In addition, in the present embodiment, the back cover 4 has a first molded body 45 and a second molded body 46, wherein, the two first fixing portions 41, the two second fixing portions 42, the two fourth mounting holes 43 and the two fifth mounting holes 44 are constructed to the first molded body 45. The first molded body 45 directly is molded on the connections between the circuit board 2 and the cables 3 to form a base, specifically, in a process of over molding the first molded body 45, a molding tool which is used for molding forwardly abuts against the cables 3, so that a rear side of the first molded body 45 has a plurality of apertures 451 which partially expose the cables 3. The second molded body 46 is molded on the rear side of the first molded body 45 and has a plurality of filling portions 461 which fill the plurality of apertures 451 respectively, because there are gaps among the cable 3, in a process of cooling and molding of the first molded body 45, the first molded body 45 is prone to shrink, and is difficult to be precisely molded, but by that the first molded body 45 and the second molded body 46 are separately molded, it may attain precise molding, and ensure positions of the cables 3, so as to avoid the cables 3 being exposed from a rear side of the back cover 4.

The two fixing posts 5 extend up and down and pass through the two first mounting holes 191, the two second mounting holes 121, the two third mounting holes 24, the two fourth mounting holes 43 and the two fifth mounting holes 44, to fix the back cover 4 and the circuit board 2 to the housing 1. Specifically, each fixing post 5 has a thread 51 which is used to interfere with the housing 1, the circuit board 2 and the back cover 4. The locking member 6 is provided to a receiving recess 122 which is positioned on the top of the top wall 12 of the housing 1, the locking member 6 is used to lock the electrical connector 100 and the mating connector which mate with each other. The pulling strap 7 is provided to the locking member 6 and is used to operate the locking member 6, the pulling strap 7 passes through a strap passing hole 47 of the back cover 4 and extends rearwardly.

Steps of a manufacturing method of the electrical connector 100 of the present embodiment are as follows.

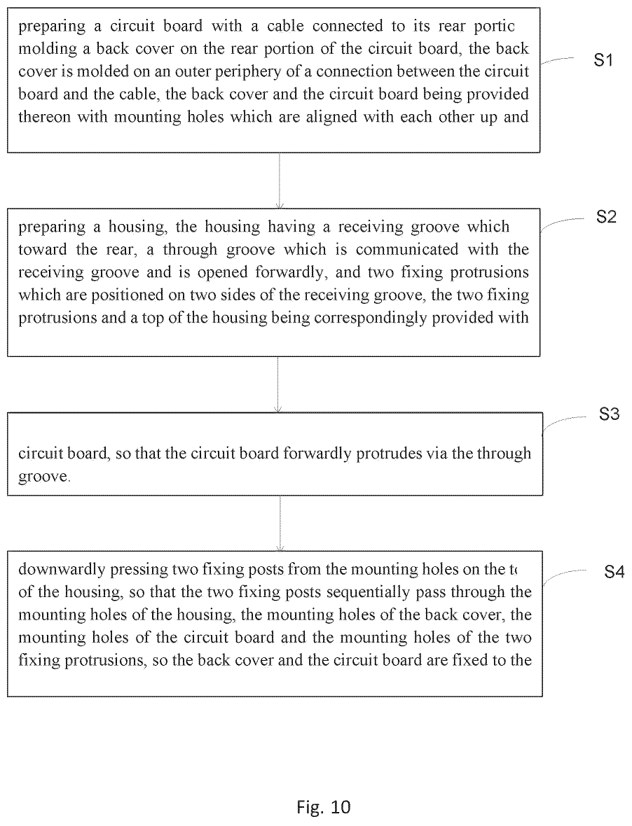

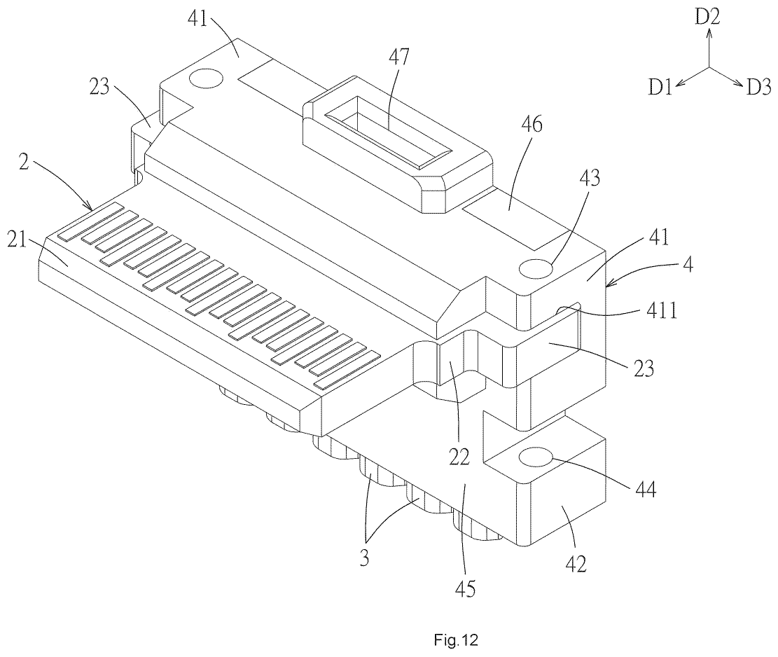

Referring to FIG. 10, FIG. 11 and FIG. 12, at step S1, preparing the circuit board 2 with the cables 3 connected to its rear portion, molding the back cover 4 on the rear portion of the circuit board 2, the back cover 4 is molded on an outer periphery of the connections between the circuit board 2 and the cables 3, so that it attains to prevent tensile stress of the cables 3 from acting on the connections to cause damage to the connections, the back cover 4 and the circuit board 2 are provided thereon with the mounting holes which are aligned with each other up and down. Specifically, the back cover 4 is provided with the two fourth mounting holes 43 which are positioned in the two first fixing portions 41, and the two fifth mounting holes 44 which are positioned to the two second fixing portions 42, the circuit board 2 is provided with the two third mounting holes 24. Wherein, in the process of molding the back cover 4 on the rear portion of the circuit board 2, firstly the first molded body 45 is molded on the outer periphery of the connections between the circuit board 2 and the cables 3 to form a base, then the second molded body 46 is further molded on the rear side of the first molded body 45. And, the two first fixing portions 41 and the two second fixing portions 42 and the mounting holes (the two fourth mounting holes 43 and the two fifth mounting holes 44) of the back cover 4 are formed when the first molded body 45 is molded on the connections of the circuit board 2 and the cables 3 to form the base.

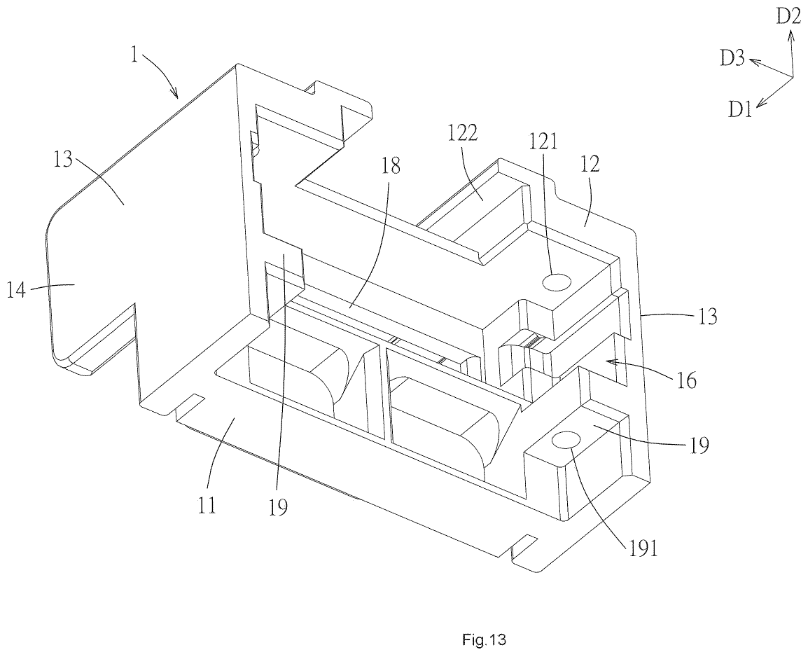

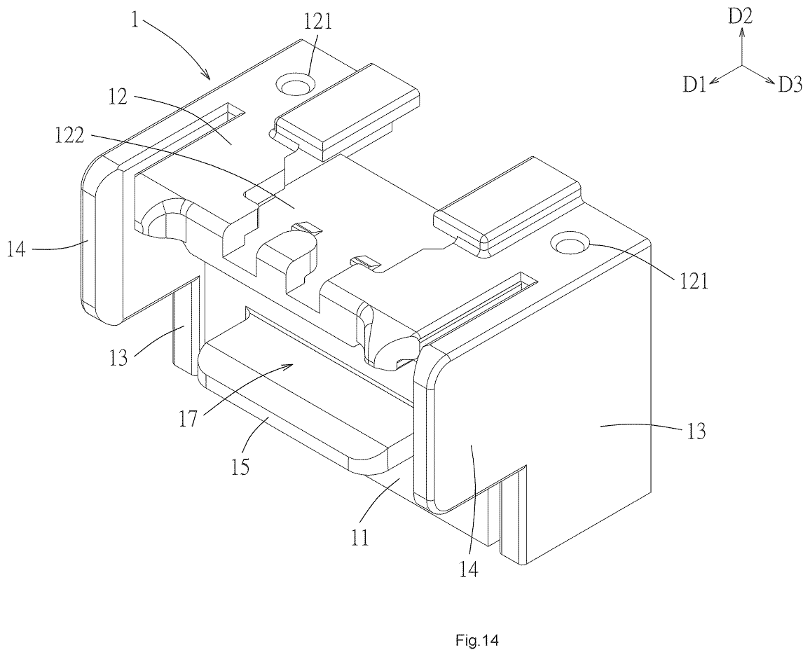

Referring to FIG. 10, FIG. 13 and FIG. 14, at step S2, preparing the housing 1, the housing 1 has the receiving groove 16 which is toward the rear, the mating cavity 17 which is toward the front, the through groove 18 which is communicated between the receiving groove 16 and the mating cavity 17 and is opened forwardly, the two fixing protrusions 19 which are positioned on the two sides of the rear segment of the receiving groove 16, the two fixing protrusions 19 and the top of the housing 1 are correspondingly provided with mounting holes. Specifically, the two fixing protrusions 19 and the top wall 12 of the housing 1 are respectively provided with the two first mounting holes 191 and the two second mounting holes 121.

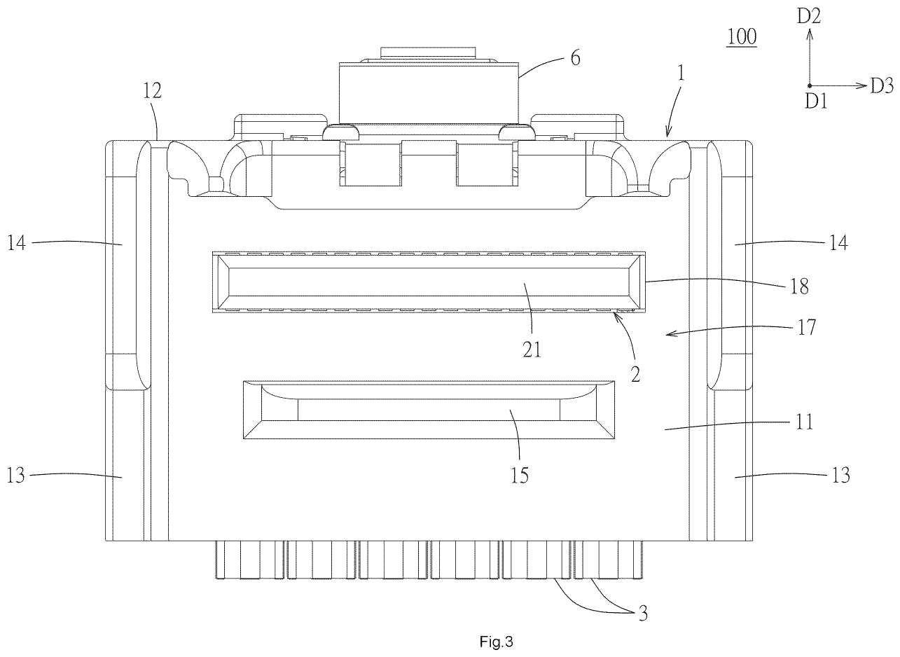

Referring to FIG. 1, FIG. 2, FIG. 3 and FIG. 10, at step S3, mounting the back cover 4 into the receiving groove 16 of the housing 1 with the circuit board 2, so that the circuit board 2 forwardly protrudes to the mating cavity 17 via the through groove 18. After mounting the back cover 4 into the receiving groove 16 of the housing 1 with the circuit board 2, the circuit board 2 forwardly protrudes to the mating cavity 17 via the through groove 18. The two fixing protrusions 19 of the housing 1 are positioned between the two first fixing portions 41 and the two second fixing portions 42. Next, at step S4, downwardly pressing the two fixing posts 5 from the mounting holes (the second mounting holes 121) on the top of the housing 1, so that the two fixing posts 5 sequentially pass through the mounting holes of the housing 1, the mounting holes of the two first fixing portions 41 of the back cover 4, the mounting holes of the circuit board 2, the mounting holes of the two fixing protrusions 19 and the mounting holes of the two second fixing portions 42 (sequentially the second mounting holes 121, the fourth mounting holes 43, the third mounting holes 24, the first mounting holes 191 and the fifth mounting holes 44), so the back cover 4 and the circuit board 2 are fixed to the housing 1, and assembling and manufacturing of the electrical connector 100 is completed.

Wherein, before step S3, the locking member 6 may be provided to the receiving recess 122 of the top wall 12 of the housing 1. And after step S3, the pulling strap 7 may be provided to the locking member 6, and the pulling strap 7 passes through the strap passing hole 47 of the back cover 4 and extends rearwardly, so that mounting of the locking member 6 and the pulling strap 7 is completed.

In conclusion, in the present disclosure, the back cover 4 which is molded on the outer periphery of the connections of the circuit board 2 and the cables 3 is molded firstly, the back cover 4 is then fixed onto the housing 1 via the two fixing posts 5, the molded back cover 4 may be more plentiful and precise, at the same time it can avoid a melted plastic flowing out via a gap between the circuit board 2 and the housing 1 to contaminate mating gold fingers on the circuit board 2.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

1. An electrical connector, comprising:
a housing comprising a receiving groove which is toward the rear, a through groove which is communicated with the receiving groove and is opened forwardly, two fixing protrusions which are positioned on two sides of the receiving groove, two first mounting holes which are respectively positioned on the two fixing protrusions and are penetratingly formed up and down, and two second mounting holes which are positioned on a top of the housing and respectively correspond to the two first mounting holes;
a circuit board comprising a mating portion which is positioned to a front portion of the circuit board, a cable connecting portion which is positioned to a rear portion of the circuit board, and two third mounting holes which respectively correspond to the two first mounting holes;
a cable electrically connected to the cable connecting portion of the circuit board;
a back cover which is molded on an outer periphery of a connection between the circuit board and the cable and mounted into the receiving groove, so that the circuit board protrudes forwardly from the through groove, the back cover comprising two first fixing portions and two fourth mounting holes which are positioned in the two first fixing portions and respectively correspond to the two first mounting holes; and
two fixing posts extending up and down and passing through the two first mounting holes, the two second mounting holes, the two third mounting holes and the two fourth mounting holes.

2. The electrical connector of claim 1, wherein
the back cover further comprises two second fixing portions which are positioned below the two first fixing portions and are spaced apart from the two first fixing portions, and two fifth mounting holes which are positioned to the two second fixing portions and respectively correspond to the two first mounting holes,
the two fixing protrusions of the housing are positioned between the two first fixing portions and the two second fixing portions, the two fixing posts further pass through to the two fifth mounting holes.

3. The electrical connector of claim 1, wherein
the back cover comprises a first molded body and a second molded body, the first molded body is directly molded on the connection between the circuit board and the cable to form a base, and the second molded body is further molded on the first molded body.

4. The electrical connector of claim 3, wherein
the two first fixing portions and the two fourth mounting holes are formed on the first molded body.

5. The electrical connector of claim 1, wherein
the housing further comprises a mating cavity which is toward the front, the through groove is communicated between the receiving groove and the mating cavity, the circuit board forwardly protrudes from the through groove to the mating cavity.

6. A manufacturing method of an electrical connector, comprising steps of:
preparing a circuit board with a cable connected to its rear portion, molding a back cover on the rear portion of the circuit board, the back cover is molded on an outer periphery of a connection between the circuit board and the cable, the back cover and the circuit board being provided thereon with mounting holes which are aligned with each other up and down;
preparing a housing, the housing having a receiving groove which is toward the rear, a through groove which is communicated with the receiving groove and is opened forwardly, and two fixing protrusions which are positioned on two sides of the receiving groove, the two fixing protrusions and a top of the housing being correspondingly provided with mounting holes;
mounting the back cover into the receiving groove of the housing with the circuit board, so that the circuit board forwardly protrudes via the through groove;
downwardly pressing two fixing posts from the mounting holes on the top of the housing, so that the two fixing posts sequentially pass through the mounting holes of the housing, the mounting holes of the back cover, the mounting holes of the circuit board and the mounting holes of the two fixing protrusions, so the back cover and the circuit board being fixed to the housing.

7. The manufacturing method of the electrical connector of claim 6, wherein
the back cover comprises two first fixing portions, and two second fixing portions which are positioned below the two first fixing portions and are spaced apart from the two first fixing portions, the two first fixing portions and the two second fixing portions both are provided with the mounting holes,
after mounting the back cover into the receiving groove of the housing with the circuit board, the two fixing protrusions of the housing are positioned between the two first fixing portions and the two second fixing portions,
after downwardly pressing the two fixing posts from the mounting holes on the top of the housing, the two fixing posts sequentially pass through the mounting holes of the housing, the mounting holes of the two first fixing portions of the back cover, the mounting holes of the circuit board, the mounting holes of the two fixing protrusions and the mounting holes of the two second fixing portions, so the back cover and the circuit board are fixed to the housing.

8. The manufacturing method of the electrical connector of claim 6, wherein
the back cover comprises a first molded body and a second molded body,
in the process of molding the back cover on the rear portion of the circuit board, firstly the first molded body is molded on the connection between the circuit board and the cable to form a base, then the second molded body is further molded on the first molded body.

9. The manufacturing method of the electrical connector of claim 8, wherein
the mounting holes of the back cover are formed when the first molded body is molded on the connections between the circuit board and the cable to form the base.

10. The manufacturing method of the electrical connector of claim 6, wherein
the housing further comprises a mating cavity which is toward the front, the through groove is communicated between the receiving groove and the mating cavity,
after mounting the back cover into the receiving groove of the housing with the circuit board, the circuit board forwardly protrudes to the mating cavity via the through groove.
